(19) United States
(12) Patent Application Publication
(10) Pub. No.: US 2022/0063616 A1
(43) Pub. Date: Mar. 3, 2022

(54) SYSTEM FOR CONTROLLING VEHICLE SPEED

(71) Applicant: HYUNDAI MOBIS CO., LTD., Seoul (KR)

(72) Inventor: Dong Pil LEE, Yongin-si (KR)

(73) Assignee: HYUNDAI MOBIS CO., LTD., Seoul (KR)

(21) Appl. No.: 17/407,827

(22) Filed: Aug. 20, 2021

(30) Foreign Application Priority Data
Aug. 28, 2020 (KR) 10-2020-0109667

(51) Int. Cl. B60W 30/14; B60W 50/14; G06N 3/08; G06N 3/04; G01C 21/34; G01C 21/00

(52) U.S. Cl. CPC B60W 30/143; B60W 50/14; G06N 3/08; G06N 3/04; B60W 2554/80; G01C 21/387; B60W 2556/50; B60W 2552/20; B60W 2554/4041; G01C 21/3492

(57) ABSTRACT

A system for controlling a speed may include: a cognition device configured to provide sensing information by sensing an object at an outside of a host vehicle; a route setting device configured to receive map update information from the outside of the host vehicle to update a map, plan a driving route to a destination set by a driver, based on the map, and provide information on the planned driving route as driving route information; a real-time driving controller configured to generate real-time driving control information, based on the sensing information and driving route information for a preset position in front of the host vehicle, among the driving route information; and a vehicle control output interface configured to provide the real-time driving control information to an engine control system, a braking control system, and a steering control system.

### CROSS-REFERENCE TO RELATED APPLICATIONS

This application claims the benefit under 35 U.S.C. § 119(a) of Korean Patent Application No. 10-2020-0109667 filed on Aug. 28, 2020 in the Korean Intellectual Property Office, the entire disclosure of which is incorporated herein by reference for all purposes.

### TECHNICAL FIELD

The present disclosure relates to a speed control technology belonging to an autonomous driving system or an advanced driver assistance system (ADAS).

### BACKGROUND

As a technology is advanced, various sensors and various electronic devices have been provided for a vehicle for the user convenience. In particular, researches and studies have been actively performed on an advanced driver assistance system (ADAS) for the convenience in driving by a user. Further, an autonomous vehicle has been actively studied.

In general, a speed control technology of the autonomous driving system or the ADAS system is to control the speed of the vehicle by computing information provided by sensors to sense an object.

Therefore, when the vehicle more rapidly performs computation to correspond to the more increased driving speed of the vehicle, the driving safety of the vehicle may be secured.

Accordingly, the autonomous driving system or the ADAS system has to employ a technology of increasing the speed of computation for information provided by sensors, for the safe driving of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a system for controlling a speed includes a route setting device configured to receive map update information from an outside of a vehicle in real time to update a map, plan a driving route to a destination set by a driver, based on the map, and provide information on the driving route as driving route information; a mode selecting device configured to provide any one of real-time driving mode activation information, off-line driving mode activation information, and driver driving mode activation information, based on whether vehicle driving mode selection information, which is selected by the driver, and the map update information are received; a real-time driving controller configured to generate real-time driving control information, based on driving route information for a preset position in front of a host vehicle, among the driving route information, in response to the real-time driving controller being activated by receiving the real-time driving mode activation information; an off-line driving controller configured to generate off-line driving control information, based on driving route information for a current position of the host vehicle, among the driving route information, in response to the off-line driving controller being activated by receiving the off-line driving mode activation information; a driver driving controller configured to transmit driver handling information, which serves as driver driving control information, in response to the driver driving controller being activated by receiving the driver driving mode activation information; and a vehicle control output interface configured to provide any one that is received from among the real-time driving control information, the off-line driving control information, and the driver driving control information, to an engine control system, a braking control system, and a steering control system.

The mode selecting device may be further configured to provide, to the real-time driving controller, only the real-time driving mode activation information among the real-time driving mode activation information, the off-line driving mode activation information, and the driver driving mode activation information, in response to the driver being determined as selecting driving through an autonomous driving system or an advanced driver assistance system (ADAS) system, based on the vehicle driving mode selection information, and further in response to the map being determined as being updated with the map update information by receiving the map update information.

The mode selecting device may be further configured to provide, to the off-line driving controller, only the off-line driving mode activation information among the real-time driving mode activation information, the off-line driving mode activation information, and the driver driving mode activation information, in response to the driver being determined as selecting driving through an autonomous driving system or an advanced driver assistance system (ADAS) system, based on the vehicle driving mode selection information, and further in response to the map not being determined as being updated with the map update information as the map update information is not received.

The mode selecting device may be further configured to provide, to the driver driving controller, only the driver driving mode activation information among the real-time driving mode activation information, the off-line driving mode activation information, and the driver driving mode activation information, regardless of whether the map update information is received, in response to the driver being determined to drive the vehicle by personally handling the vehicle, based on the vehicle driving mode selection information.

The real-time driving controller may be further configured to generate the real-time driving control information, based on the driving route information for the preset position in front of the host vehicle, by using data on a virtual vehicle modeled depending on a specification of the host vehicle.

The real-time driving controller may include: a host-vehicle modeling data storage configured to store the data on the virtual vehicle modeled depending on the specification of the host vehicle, and provide the stored data as vehicle modeling data; a road curvature calculating device configured to calculate a curvature of a driving road, which is sensed at the preset position in front of the host vehicle, based on the driving route information, and provide a result of the calculation as driving route curvature information; a neural network vehicle model learning device configured to generate a speed prediction model, based on the vehicle modeling data and the driving route curvature information; and a vehicle speed planning device configured to generate the real-time driving control information, based on the speed prediction model.

The neural network vehicle model learning device may be further configured to generate the speed prediction model by learning information on the curvature of the driving road based on the vehicle modeling data.

In another general aspect, a system for controlling a speed includes: a cognition device configured to provide sensing information by sensing an object at an outside of a host vehicle; a route setting device configured to receive map update information from the outside of the host vehicle to update a map, plan a driving route to a destination set by a driver, based on the map, and provide information on the planned driving route as driving route information; a real-time driving controller configured to generate real-time driving control information, based on the sensing information and driving route information for a preset position in front of the host vehicle, among the driving route information; and a vehicle control output interface configured to provide the real-time driving control information to an engine control system, a braking control system, and a steering control system.

The real-time driving controller may be further configured to generate the real-time driving control information, based on the sensing information and the driving route information for the preset position in front of the host vehicle, by using data on a virtual vehicle modeled depending on a specification of the host vehicle.

The real-time driving controller may include: a host-vehicle modeling data storage configured to store the data on the virtual vehicle modeled depending on the specification of the host vehicle, and to provide the stored data as vehicle modeling data; a road curvature calculating device configured to calculate a curvature of a driving road, which is sensed at the preset position in front of the host vehicle, based on the driving route information, and to provide a result of the calculation as driving route curvature information; a neural network vehicle model learning device configured to generate a speed prediction model, based on the vehicle modeling data and the driving route curvature information; and a vehicle speed planning device configured to generate the real-time driving control information, based on the speed prediction model and the sensing information.

The speed prediction model may include information on acceleration and deceleration of the host vehicle.

The neural network vehicle model learning device may be further configured to generate the speed prediction model by learning information on the curvature of the driving road based on the vehicle modeling data.

The vehicle speed planning device may be further configured to generate the real-time driving control information, depending on a position of an object and a distance to the object, which are included in the sensing information, based on the speed prediction model.

The vehicle speed planning device may be further configured to decelerate a speed of the host vehicle, which is included in the speed prediction model, based on the sensing information.

In another general aspect, a method for controlling a speed includes: providing sensing information by sensing an object at an outside of a host vehicle; receiving map update information from the outside of the host vehicle to update a map, planning a driving route to a destination set by a driver, based on the updated map, and providing information on the planned driving route as driving route information; generating real-time driving control information, based on the sensing information and driving route information for a preset position in front of the host vehicle, among the driving route information; and providing the real-time driving control information to an engine control system, a braking control system, and a steering control system.

The generating of the real-time driving control information may include: generating the real-time driving control information, based on the sensing information and the driving route information for the preset position in front of the host vehicle, by using data on a virtual vehicle modeled depending on a specification of the host vehicle.

The generating of the real-time driving control information may include: storing the data on the virtual vehicle modeled depending on the specification of the host vehicle, and providing the stored data as vehicle modeling data; calculating a curvature of a driving road, which is sensed at the preset position in front of the host vehicle, based on the driving route information, and providing a result of the calculation as driving route curvature information; generating a speed prediction model by using a neural network, based on the vehicle modeling data and the driving route curvature information; and generating the real-time driving control information, based on the speed prediction model and the sensing information.

The generating of the real-time driving control information may further include: generating the real-time driving control information, depending on a position of an object and a distance to the object, which are included in the sensing information, based on the speed prediction model.

The generating of the real-time driving control information may further include: decelerating a speed of the host vehicle, which is included in the speed prediction model, depending on the position of the object and the distance to the object, which are included in the sensing information.

The generating of the speed prediction model may include generating the speed prediction model by learning information on the curvature of the driving road, based on the vehicle modeling data.

Other features and aspects will be apparent from the following detailed description, the drawings, and the claims.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating the configuration of a vehicle speed control system, according to an embodiment of the present disclosure;

FIG. 2 is a view illustrating the configuration of a real-time driving controller of a vehicle speed control system, according to an embodiment of the present disclosure;

FIG. 3 is a flowchart illustrating a vehicle speed planning device included in a real-time driving controller of a vehicle speed control system, according to an embodiment of the present disclosure; and

FIGS. 4A and 4B are views illustrating a vehicle speed control system, according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In addition, in the following description of components according to an embodiment of the present disclosure, the terms ‘first’, ‘second’, ‘A’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application

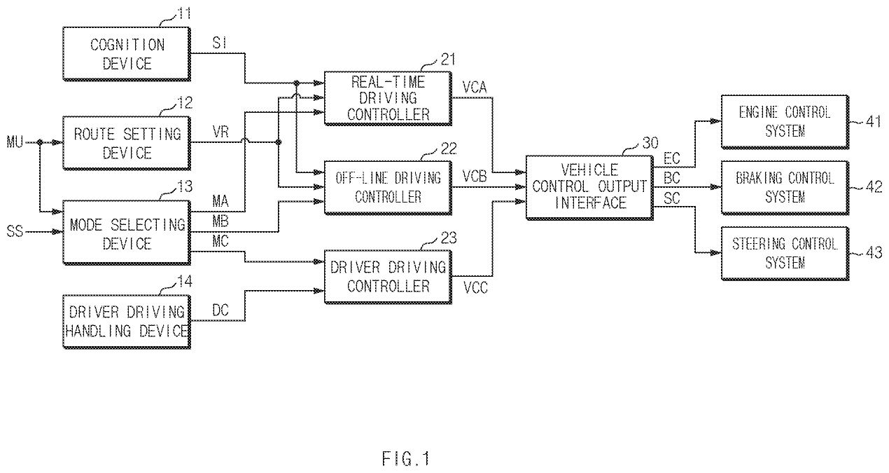

Hereinafter, embodiments of the present disclosure will be described in detail with reference to FIGS. 1 to 4B.

FIG. 1 is a view illustrating the configuration of a vehicle speed control system, according to an embodiment of the present disclosure.

Referring to FIG. 1, according to an embodiment of the present disclosure, the vehicle speed control system may be implemented inside a vehicle. In this case, a real-time driving controller 21 may be formed integrally with the internal control units of the vehicle or may be implemented separately from the internal control units of the vehicle to be connected with the internal control units of the vehicle through a separate connector.

Referring to FIG. 1, according to an embodiment of the present disclosure, the vehicle speed control system may include a cognition device 11, a route setting device 12, a mode selecting device 13, a driver driving handling device 14, the real-time driving controller 21, an off-line driving controller 22, a driver driving controller 23, and a vehicle control output interface 30.

In this case, the vehicle control output interface 30 may generate engine control information (EC), braking control information (BC), and steering control information (SC), based on information provided by one of the real-time driving controller 21, the off-line driving controller 22, and the driver driving controller 23. In addition, the vehicle control output interface 30 may provide the engine control information (EC) to an engine control system 41, may provide the braking control information (BC) to a braking control system 42, and may provide steering control information (SC) to a steering control system 43.

The cognition device 11 may include at least one sensor to recognize an object present outside the vehicle.

The cognition device 11 may include at least one sensor, such as a radar, Lidar, a camera, an infrared sensor, and an ultrasonic sensor, used in the autonomous driving system or the ADAS system.

The cognition device 11 may recognize the object present outside the vehicle and may provide the recognition result, which serves as sensing information (SI), to the real-time driving controller 21 and the off-line driving controller 22.

The route setting device 12 may plan a route to a destination from a current position, based on a map stored, when the destination is set by the driver, and may provide information, which serves as driving route information (VR), on the planed route, to the real-time driving controller 21 and the off-line driving controller 22.

In this case, the route setting device 12 may receive map update information (MU), which is used for updating the map, from the outside of the vehicle in real time, and may update the stored map with the received map update information (MU).

The mode selecting device 13 may generate one of real-time driving mode activation information (MA), off-line driving mode activation information (MB), and driver driving mode activation information (MC), based on vehicle driving mode selection information (SS) obtained through the selection of the driver, and the map update information (MU).

In this case, the vehicle driving mode selection information (SS) may include information on that the driver selects autonomous driving or semi-autonomous driving through the autonomous driving system or the ADAS system, and may include information on the selection of the driver that the driver drives the vehicle by personally handling the vehicle.

For example, the mode selecting device 13 may generate the real-time driving mode activation information (MA) of the real-time driving mode activation information (MA), the off-line driving mode activation information (MB), and the driver driving mode activation information (MC), when the driver is determined as selecting the driving through the autonomous driving system or the ADAS system, based on the vehicle driving mode selection information (SS) and when the stored map is determined as being updated with the map update information (MU).

For example, the mode selecting device 13 may generate the off-line driving mode activation information (MB) of the real-time driving mode activation information (MA), the off-line driving mode activation information (MB), and the driver driving mode activation information (MC), when the driver is determined as selecting the driving through the autonomous driving system or the ADAS system, based on the vehicle driving mode selection information (SS) and when the stored map is not determined as being updated with map update information (MU).

The mode selecting device 13 may generate the driver driving mode activation information (MC) of the real-time driving mode activation information (MA), the off-line driving mode activation information (MB), and the driver driving mode activation information (MC), regardless of the map update information (MU), when the driver is determined to drive the vehicle by personally handling the vehicle, based on the vehicle driving mode selection information (SS).

The driver driving handling device 14 may provide, to the driver driving controller 23, information on the steering, acceleration, and braking of the vehicle by driver, as driver handling information (DC).

In this case, the driver driving handling device 14 may include a steering device, an accelerator, and a braking device allowing the driver to control vehicle driving.

The real-time driving controller 21 may generate real-time driving control information (VCA) based on the real-time driving mode activation information (MA), the sensing information (SI), the driving route information (VR), and data on a virtual vehicle modeled depending on a specification of a host vehicle.

For example, the real-time driving controller 21 may be activated when the real-time driving mode activation information (MA) is input, and the activated real-time driving controller 21 may generate the real-time driving control information (VCA), based on the sensing information (SI) and the driving route information (VR).

In more detail, the real-time driving controller 21, which is activated, may generate the real-time driving control information (VCA), which is based on the sensing information (SI) and the sensed driving route information (VR) at a preset position in front of the host vehicle, by using the data on the virtual vehicle modeled depending on the specification of the host vehicle.

In particular, the real-time driving controller 21, which is activated, may calculate the curvature of a driving route, which is based on the sensing information (SI) and the driving route information (VR) sensed at the preset position in front of the host vehicle, and may calculate the speed of the host vehicle, which arrives at the preset position through a preset algorithm, by applying the curvature, which is calculated based on the data on the virtual vehicle. In this case, the real-time driving control information (VCA) provided by the real-time driving controller 21 may include a speed plan (acceleration and deceleration) of the host vehicle.

The off-line driving controller 22 may generate off-line driving control information (VCB) based on the off-line driving mode activation information (MB), the sensing information (SI), and the driving route information (VR).

For example, the off-line driving controller 22 is activated when the off-line driving mode activation information (MB) is input, and the activated off-line driving controller 22 may generate the off-line driving control information (VCB) based on the sensing information (SI), and the driving route information (VR).

In more detail, the off-line driving controller 22, which is activated, may generate off-line driving control information (VCB) for a current position of the host vehicle, based on the sensing information (SI), and the driving route information (VR).

In particular, the activated off-line driving controller 22 may calculate the curvature of the driving route based on the sensing information (SI) and the driving route information (VR) for the current position of the host vehicle, and may calculate a speed based on the calculated curvature, through a preset algorithm. In this case, the off-line driving control information (VCB) provided by the off-line driving controller 22 may include the information on the speed plan (acceleration, deceleration, and braking) of the host vehicle.

The driver driving controller 23 may provide, to the vehicle control output interface 30, driver driving control information (VCC) based on the driver driving mode activation information (MC) and the driver handling information (DC).

For example, the driver driving controller 23 may be activated when the driver driving mode activation information (MC) is activated. The activated driver driving controller 23 may provide the driver handling information (DC), which serves as the driver driving control information (VCC), to the vehicle control output interface 30.

The vehicle control output interface 30 may provide driving control information, which is provided by one activated of the real-time driving controller 21, the off-line driving controller 22, and the driver driving controller 23, to the engine control system 41, the braking control system 42, and the steering control system 43.

For example, the vehicle control output interface 30 may provide, to the engine control system 41, acceleration information, which serves as the engine control information (EC), of the real-time driving control information (VCA) provided by the real-time driving controller 21 which is activated among the real-time driving controller 21, the off-line driving controller 22, and the driver driving controller 23, may provide, to the braking control system 42, deceleration information, which serves as the braking control information (BC), of the real-time driving control information (VCA), and may provide, to the steering control system 43, steering information, which serves as the steering control information (SC), of the real-time driving control information (VCA).

The engine control system 41 may increase the speed of the host vehicle based on the engine control information (EC). In other words, the engine control system 41 may increase the acceleration of the host vehicle based on the engine control information (EC).

The braking control system 42 may decrease the speed of the host vehicle based on the braking control information (BC).

The steering control system 43 may determine the driving direction of the host vehicle, based on the steering control information (SC).

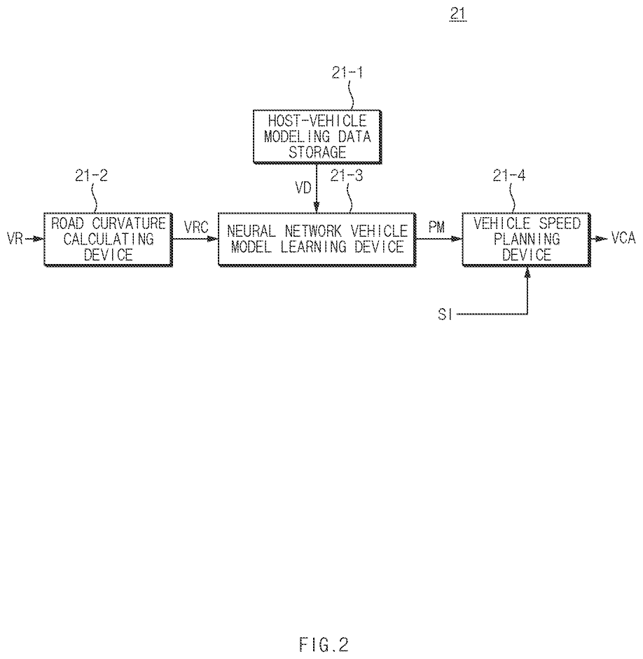

According to an embodiment of the present disclosure, the real-time driving controller 21 constituting the vehicle speed control system may be configured as in illustrated in FIG. 2.

Referring to FIG. 2, the real-time driving controller 21 may include a host-vehicle modeling data storage 21-1, a road curvature calculating device 21-2, a neural network vehicle model learning device 21-3, and a vehicle speed planning device 21-4.

The host-vehicle modeling data storage 21-1 may store data on a virtual vehicle modeled depending on the specification of the host vehicle.

In addition, the host-vehicle modeling data storage 21-1 may provide, to the neural network vehicle model learning device 21-3, the stored data on the virtual vehicle which serves as vehicle modeling data (VD).

The road curvature calculating device 21-2 may calculate the curvature of the driving road, which is sensed at the preset position in front of the host vehicle, based on the driving route information (VR), and may provide the calculation result, which serves as driving route curvature information (VRC), to the neural network vehicle model learning device 21-3.

The neural network vehicle model learning device 21-3 may generate a speed prediction model (PM), based on the vehicle modeling data (VD) and the driving route curvature information (VRC), and may provide the speed prediction model (PM) to the vehicle speed planning device 21-4.

In this case, the speed prediction model (PM) may include information on acceleration and deceleration of the vehicle.

For example, the neural network vehicle model learning device 21-3 may generate the speed prediction model (PM) by learning the driving route curvature information (VRC), based on the vehicle modeling data (VD).

The vehicle speed planning device 21-4 may generate the real-time driving control information (VCA), based on the speed prediction model (PM) and the sensing information (SI).

In this case, the real-time driving control information (VCA) may include information on the acceleration and the deceleration of the vehicle.

For example, the vehicle speed planning device 21-4 may generate the real-time driving control information (VCA), depending on a position of an object and a distance to the object, which are included in the sensing information (SI), based on the speed prediction model (PM).

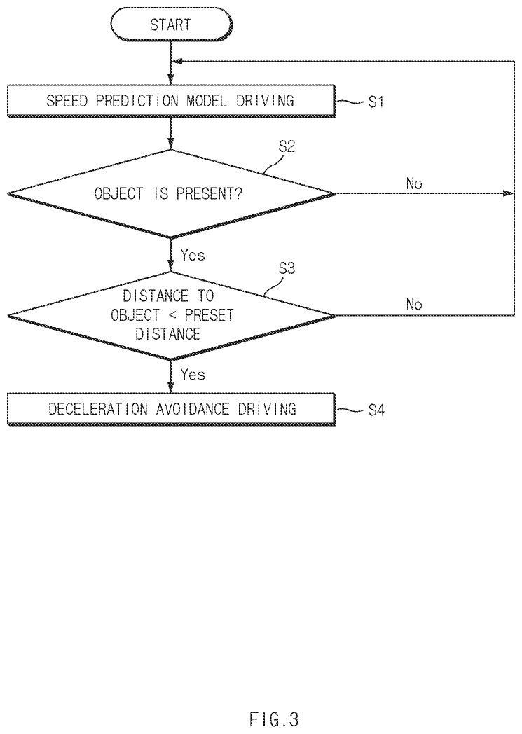

Hereinafter, the operation of the vehicle speed planning device 21-4 will be described in more detail with reference to FIG. 3.

The operating method of the vehicle speed planning device 21-4 may include a speed prediction model driving step (S1), an object presence determining step (S2), a distance-to-object determining step (S3), and a deceleration avoidance driving step (S4).

The speed prediction model driving step (S1) may include a step in which the vehicle speed planning device 21-4 provides the speed prediction model (PM), which serves as the real-time driving control information (VCA) and is provided by the neural network vehicle model learning device 21-3, to the vehicle control output interface 30.

In this case, in the speed prediction model driving step (S1), the vehicle speed planning device 21-4 provides the speed prediction model (PM), which serves as the real-time driving control information (VCA) and is provided by the neural network vehicle model learning device 21-3, to the vehicle control output interface 30, regardless of the sensing information (SI).

The object presence determining step (S2) may include the step in which the vehicle speed planning device 21-4 determines whether an object is present at a preset position in front of the host vehicle, based on the sensing information (SI).

When the object is not determined as being sensed at the preset position in front of the host vehicle in the object presence determining step (S2; “No”) in the object presence determining step (S2), the speed prediction model driving step (S1) may be executed again.

Meanwhile, when the object is determined as being sensed at the preset position in front of the host vehicle in the object presence determining step (S2; “Yes”), the distance-to-object determining step (S3) may be executed.

The distance-to-object determining step (S3) may include the step of performing one of the speed prediction model driving step (S1) or the deceleration avoidance driving step (S4), depending on the distance between the host vehicle and the sensed object.

When the distance between the host vehicle and the sensed object exceeds a preset distance in the distance-to-object determining step (S3; “No”), the speed prediction model driving step (S1) may be performed.

Meanwhile, when the distance between the host vehicle and the sensed object is equal to or less than a preset distance in the distance-to-object determining step (S3), the deceleration avoidance driving step (S4) may be performed.

The deceleration avoidance driving step (S4) may include the step in which the host vehicle drives by reducing the speed included in the speed prediction model (PM) in the speed prediction model driving step (S1), and the step in which the driver drives while avoiding the object, based on the distance to the object and the position of the object which are included in the sensing information (SI).

In this case, the deceleration avoidance driving step (S4) may include the step in which the vehicle speed planning device 21-4 reduces the speed included in the speed prediction model (PM) provided by the neural network vehicle model learning device 21-3 and provides the speed prediction model (PM) serving as the real-time driving control information (VCA) to the vehicle control output interface 30.

According to an embodiment of the present invention, as described above, the vehicle speed control system may generate the real-time driving control information (VCA), which is based on the sensing information (SI) and the driving route information (VR) sensed at the preset position in front of the host vehicle, by using the data on the virtual vehicle modeled depending on the specification of the host vehicle.

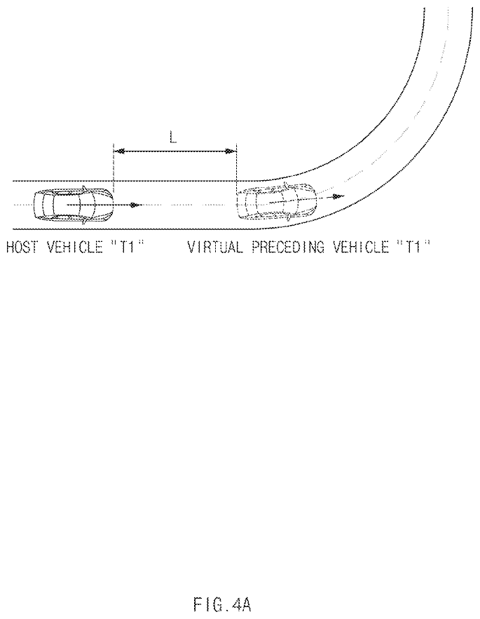

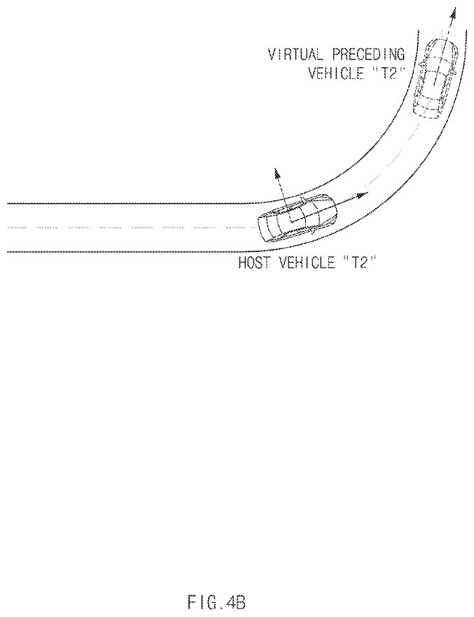

Accordingly, as illustrated in FIGS. 4A and 4B, according to an embodiment of the present disclosure, the vehicle speed control system may allow the virtual vehicle to precede the host vehicle, by applying the sensing information (SI) and the driving route information (VR) sensed at the preset position (distance; L) in front of the host vehicle, to the virtual vehicle modeled depending on the specification of the host vehicle.

In addition, according to an embodiment of the present disclosure, the vehicle speed control system may plan the speed of the host vehicle in advance by calculating the speed of the host vehicle at the preset position, as the virtual vehicle modeled depending on the specification of the host vehicle is allowed to precede the host vehicle at the preset position in front of the host vehicle.

According to the present disclosure, since the vehicle speed is controlled by predicting and computing the vehicle speed depending on the curvature of the driving road, the driving safety of the vehicle may be enhanced.

Besides, a variety of effects directly or indirectly understood through the disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A system for controlling a speed, the system comprising:
a route setting device configured to:
receive map update information from an outside of a vehicle in real time to update a map;
plan a driving route to a destination set by a driver, based on the map; and
provide information on the driving route as driving route information;
a mode selecting device configured to provide any one of real-time driving mode activation information, off-line driving mode activation information, and driver driving mode activation information, based on whether vehicle driving mode selection information, which is selected by the driver, and the map update information are received;
a real-time driving controller configured to generate real-time driving control information, based on driving route information for a preset position in front of a host vehicle, among the driving route information, in response to the real-time driving controller being activated by receiving the real-time driving mode activation information;
an off-line driving controller configured to generate off-line driving control information, based on driving route information for a current position of the host vehicle, among the driving route information, in response to the off-line driving controller being activated by receiving the off-line driving mode activation information;
a driver driving controller configured to transmit driver handling information, which serves as driver driving control information, in response to the driver driving controller being activated by receiving the driver driving mode activation information; and
a vehicle control output interface configured to provide any one that is received from among the real-time driving control information, the off-line driving control information, and the driver driving control information, to an engine control system, a braking control system, and a steering control system.

2. The vehicle of claim 1, wherein the mode selecting device is further configured to provide, to the real-time driving controller, only the real-time driving mode activation information among the real-time driving mode activation information, the off-line driving mode activation information, and the driver driving mode activation information, in response to the driver being determined as selecting driving through an autonomous driving system or an advanced driver assistance system (ADAS) system, based on the vehicle driving mode selection information, and further in response to the map being determined as being updated with the map update information by receiving the map update information.

3. The vehicle of claim 1, wherein the mode selecting device is further configured to provide, to the off-line driving controller, only the off-line driving mode activation information among the real-time driving mode activation information, the off-line driving mode activation information, and the driver driving mode activation information, in response to the driver being determined as selecting driving through an autonomous driving system or an advanced driver assistance system (ADAS) system, based on the vehicle driving mode selection information, and further in response to the map not being determined as being updated with the map update information as the map update information is not received.

4. The vehicle of claim 1, wherein the mode selecting device is further configured to provide, to the driver driving controller, only the driver driving mode activation information among the real-time driving mode activation information, the off-line driving mode activation information, and the driver driving mode activation information, regardless of whether the map update information is received, in response to the driver being determined to drive the vehicle by personally handling the vehicle, based on the vehicle driving mode selection information.

5. The vehicle of claim 1, wherein the real-time driving controller is further configured to generate the real-time driving control information, based on the driving route information for the preset position in front of the host vehicle, by using data on a virtual vehicle modeled depending on a specification of the host vehicle.

6. The vehicle of claim 5, wherein the real-time driving controller includes:
a host-vehicle modeling data storage configured to store the data on the virtual vehicle modeled depending on the specification of the host vehicle, and provide the stored data as vehicle modeling data;
a road curvature calculating device configured to calculate a curvature of a driving road, which is sensed at the preset position in front of the host vehicle, based on the driving route information, and provide a result of the calculation as driving route curvature information;
a neural network vehicle model learning device configured to generate a speed prediction model, based on the vehicle modeling data and the driving route curvature information; and
a vehicle speed planning device configured to generate the real-time driving control information, based on the speed prediction model.

7. The system of claim 6, wherein the neural network vehicle model learning device is further configured to generate the speed prediction model by learning information on the curvature of the driving road based on the vehicle modeling data.

8. A system for controlling a speed, the system comprising:
a cognition device configured to provide sensing information by sensing an object at an outside of a host vehicle;
a route setting device configured to:
receive map update information from the outside of the host vehicle to update a map;
plan a driving route to a destination set by a driver, based on the map; and
provide information on the planned driving route as driving route information;
a real-time driving controller configured to generate real-time driving control information, based on the sensing information and driving route information for a preset position in front of the host vehicle, among the driving route information; and
a vehicle control output interface configured to provide the real-time driving control information to an engine control system, a braking control system, and a steering control system.

9. The system of claim 8, wherein the real-time driving controller is further configured to generate the real-time driving control information, based on the sensing information and the driving route information for the preset position in front of the host vehicle, by using data on a virtual vehicle modeled depending on a specification of the host vehicle.

10. The system of claim 9, wherein the real-time driving controller includes:
a host-vehicle modeling data storage configured to store the data on the virtual vehicle modeled depending on the specification of the host vehicle, and to provide the stored data as vehicle modeling data;
a road curvature calculating device configured to calculate a curvature of a driving road, which is sensed at the preset position in front of the host vehicle, based on the driving route information, and to provide a result of the calculation as driving route curvature information;
a neural network vehicle model learning device configured to generate a speed prediction model, based on the vehicle modeling data and the driving route curvature information; and
a vehicle speed planning device configured to generate the real-time driving control information, based on the speed prediction model and the sensing information.

11. The system of claim 10, wherein the speed prediction model includes information on acceleration and deceleration of the host vehicle.

12. The system of claim 10, wherein the neural network vehicle model learning device is further configured to generate the speed prediction model by learning information on the curvature of the driving road based on the vehicle modeling data.

13. The system of claim 10, wherein the vehicle speed planning device is further configured to generate the real-time driving control information, depending on a position of an object and a distance to the object, which are included in the sensing information, based on the speed prediction model.

14. The system of claim 13, wherein the vehicle speed planning device is further configured to decelerate a speed of the host vehicle, which is included in the speed prediction model, based on the sensing information.

15. A method for controlling a speed, the method comprising:
providing sensing information by sensing an object at an outside of a host vehicle;
receiving map update information from the outside of the host vehicle to update a map, planning a driving route to a destination set by a driver, based on the updated map, and providing information on the planned driving route as driving route information;
generating real-time driving control information, based on the sensing information and driving route information for a preset position in front of the host vehicle, among the driving route information; and
providing the real-time driving control information to an engine control system, a braking control system, and a steering control system.

16. The method of claim 15, wherein the generating of the real-time driving control information includes:
generating the real-time driving control information, based on the sensing information and the driving route information for the preset position in front of the host vehicle, by using data on a virtual vehicle modeled depending on a specification of the host vehicle.

17. The method of claim 16, wherein the generating of the real-time driving control information includes:
storing the data on the virtual vehicle modeled depending on the specification of the host vehicle, and providing the stored data as vehicle modeling data;
calculating a curvature of a driving road, which is sensed at the preset position in front of the host vehicle, based on the driving route information, and providing a result of the calculation as driving route curvature information;
generating a speed prediction model by using a neural network, based on the vehicle modeling data and the driving route curvature information; and
generating the real-time driving control information, based on the speed prediction model and the sensing information.

18. The method of claim 17, wherein the generating of the real-time driving control information further includes:
generating the real-time driving control information, depending on a position of an object and a distance to the object, which are included in the sensing information, based on the speed prediction model.

19. The method of claim 18 wherein the generating of the real-time driving control information further includes:
decelerating a speed of the host vehicle, which is included in the speed prediction model, depending on the position of the object and the distance to the object, which are included in the sensing information.

20. The method of claim 16, wherein the generating of the speed prediction model includes:
generating the speed prediction model by learning information on the curvature of the driving road, based on the vehicle modeling data.
